(19) United States
(12) Patent Application Publication
(10) Pub. No.: US 2009/0041278 A1
(43) Pub. Date: Feb. 12, 2009

(54) Hearing apparatus with adjusted components

(75) Inventor: Volker Gebhardt, Neunkirchen am Brand (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL INSTRUMENTS PTE. LTD.

(21) Appl. No.: 12/221,939

(22) Filed: Aug. 7, 2008

(30) Foreign Application Priority Data
Aug. 9, 2007 (DE) 10 2007 037 660.1

(51) Int. Cl. H04R 25/00

(52) U.S. Cl. 381/324

(57) ABSTRACT

To minimize an unusable free volume in a housing of a hearing apparatus, a hearing apparatus is proposed, which includes a housing, which has a predetermined form and at least one active, electronic component, which is arranged in the housing, with the component having a form, which is adjusted to the form of the housing and/or to the form of another component of the hearing apparatus. As a result, the unusable residual volume in the hearing apparatus can be minimized and a smaller form of the housing can in general thus be achieved.

### CROSS REFERENCE TO RELATED APPLICATIONS

This application claims priority of German application No. 10 2007 037 660.1 DE filed Aug. 9, 2007, which is incorporated by reference herein in its entirety.

### FIELD OF INVENTION

The present invention relates to a hearing apparatus with a housing, which has a predetermined form and at least one active, electronic component, which is arranged in the housing. The term hearing apparatus is understood here to mean in particular a hearing device. Furthermore, this term also includes other wearable and non-wearable acoustic devices such as headsets, earphones and such like.

### BACKGROUND OF INVENTION

Hearing devices are wearable hearing apparatuses which are used to assist the hard-of-hearing. In order to accommodate numerous individual requirements, various types of hearing devices are available such as behind-the-ear (BTE) hearing devices, hearing device with an external receiver (RIC: receiver in the canal) and in-the-ear (ITE) hearing devices, for example also concha hearing devices or completely-in-the-canal (ITE, CIC) hearing devices. The hearing devices listed as examples are worn on the outer ear or in the auditory canal. Bone conduction hearing aids, implantable or vibrotactile hearing aids are also available on the market. The damaged hearing is thus stimulated either mechanically or electrically.

The key components of hearing devices are principally an input converter, an amplifier and an output converter. The input converter is normally a receiving transducer e.g. a microphone and/or an electromagnetic receiver, e.g. an induction coil. The output converter is most frequently realized as an electroacoustic converter e.g. a miniature loudspeaker, or as an electromechanical converter e.g. a bone conduction hearing aid. The amplifier is usually integrated into a signal processing unit. This basic configuration is illustrated in FIG. 1 using the example of a behind-the-ear hearing device. One or a plurality of microphones 2 for recording ambient sound are built into a hearing device housing 1 to be worn behind the ear. A signal processing unit 3 which is also integrated into the hearing device housing 1 processes and amplifies the microphone signals. The output signal for the signal processing unit 3 is transmitted to a loudspeaker or receiver 4, which outputs an acoustic signal. Sound is transmitted through a sound tube, which is affixed in the auditory canal by means of an otoplastic, to the device wearer's eardrum. Power for the hearing device and in particular for the signal processing unit 3 is supplied by means of a battery 5 which is also integrated in the hearing device housing 1.

Modern hearing devices are nowadays no longer understood as purely hearing aids and voice amplifiers. Aside from the technical functionality and equipment, aspects such as the form factor, size and wearing comfort are gaining increasing significance. The creative freedom in respect of the form factor and size of hearing devices is significantly restricted by the arrangement, dimensions and form of the components arranged therein.

Hearing devices consist of a plurality of electronic and mechanical components, which have a specific minimum component volume due to their physical mode of operation, with it not being possible to exceed said component volume in the case of the current prior art without experiencing losses in terms of functionality. Many hearing device components may have been miniaturized in the past years, the majority of components like for instance, microphone, receiver, batteries were however hitherto only available in standard forms. With microphones and receivers, the predominant acoustic reasons for the minimal possible housing volume are decisive. The function-bound arrangement of the hearing device components in the hearing device thus results in a free volume in the hearing device, which results in an unnecessary enlargement of the hearing device. In particular, the creative freedom in respect of size and wearing comfort is restricted by the use of square and/or cylindrical components. This is particularly the case with high-performance hearing devices, which are necessary with a more significant hearing loss. With these hearing devices, the hearing device receiver requires a large part of the housing volume.

The above problem was previously only solved partially, e.g. by adjusting the components to be created freely, like the housing, reinforcers, component holders and printed circuit boards on the free residual volume present in the hearing device. A restriction to specific hearing device forms is also conventionally made in order as a result to minimize the free residual volume in the hearing device which is specified by the components. A removal of the components from the hearing device into the auditory canal represents a further partial solution to the above-cited problem. The device housing positioned behind the ear is thus minimized in the case of so-called receiver-in-the-canal-devices.

The publication DE 202004019744 U1 discloses a behind-the-ear hearing device with a housing, which has a battery compartment opening. The behind-the-ear hearing device includes a chassis arranged in the housing, which supports electrical components. The chassis is dimensioned here such that it can be inserted through the battery compartment opening together with the components fastened thereto.

### SUMMARY OF INVENTION

An object of the present invention is to minimize an unusable residual volume in a hearing apparatus.

This object is achieved by a hearing apparatus with a housing, which has a predetermined form and at least one active, electronic component, which is a receiver or a microphone and which is arranged in the housing, with the component having a form which is adjusted to the form of the housing and/or to the form of another component of the hearing apparatus.

The unusable residual volume in the hearing apparatus can thus advantageously be minimized. A smaller housing form of the hearing apparatus can in general also be achieved by correspondingly molding the component and/or the component housing. The form of the electronic component of the hearing apparatus can now be selected such that its electrical and/or acoustic functionality remains complete, but a smaller or more variable housing form is possible by minimizing the remaining residual volume.

The component housing of the active, electronic component preferably has a trapezoidal, triangular or oval cross-section. The use of ergonomic forms of the component, as they are known above, allows the hearing apparatus to be better adjusted to the anatomical conditions of a person wearing the hearing apparatus.

The hearing apparatus can preferably be embodied as an in-the-ear hearing device, with the form of the active electronic component being adjusted to a shell of the hearing device and the shell being adjusted to the anatomy of an auditory canal of a person wearing the hearing apparatus. With in-the-ear hearing devices, the form of the housing is predetermined by the anatomy of the auditory canal. The diameter of the auditory canal reduces increasingly in the direction of the ear drum. By way of example, smaller devices can be realized by using a form of the component with a trapezoid-like cross-section. The smaller structure again allows the number of hearing-impaired persons, which can be supplied with hearing devices of this type, to be increased.

The hearing apparatus can preferably be embodied as a behind-the-ear hearing device, with the form of the active, electronic component being adjusted to a space between a concha and the head of a person wearing the hearing apparatus. A receiver in the case of behind-the-ear hearing devices is usually positioned in the upper part of the housing. In particular, with high-performance hearing devices with a large receiver, this results in an extension of the housing and thus in restricted wearing comfort. The use of receivers with a trapezoidal cross-section for instance allows behind-the-ear hearing devices to be better adjusted to the anatomy of the hearing device wearer and/or smaller devices to be manufactured.

In particular, by adjusting the components of the hearing apparatus to one another, the unusable residual volume in the hearing apparatus can be minimized. Several microphones can thus be provided in the hearing apparatus for instance, which have a trapezoidal cross-section in each instance and are arranged adjacent to one another. Such an arrangement of the microphone or also other components allows a smaller form of the housing to be achieved.

If the active, electronic component is arranged in direct proximity to an induction coil, it can be adjusted to the induction coil such that it surrounds the induction coil at least in sections. By surrounding the induction coil, the use of the volume which is available in the hearing apparatus can be improved further. If the component is a receiver, the dimensions of the receiver can as a result be increased, which can be used to increase the performance of the receiver.

The form of the active, electronic component can preferably be adjusted to the form of the housing of the hearing apparatus such that a rounded section of the component is formed at least in sections. The unusable volume in the housing can thus be reduced particularly with a hearing device which has a housing with an oval form. The housing can thus either be designed to be smaller for instance or the dimensions of the components are enlarged.

### BRIEF DESCRIPTION OF THE DRAWINGS

Examples of the present invention are described in more detail with reference to the appended drawings, in which;

FIG. 1 shows a schematic design of a behind-the-ear hearing device according to the prior art;

FIG. 2 shows an arrangement of a receiver in a behind-the-ear hearing device;

FIG. 3 shows an arrangement of a receiver in an in-the-ear hearing device;

FIG. 4 shows an arrangement of several components in a behind-the-ear hearing device according to the first exemplary embodiment;

FIG. 5 shows an arrangement of several components in a behind-the-ear hearing device according to a second exemplary embodiment.

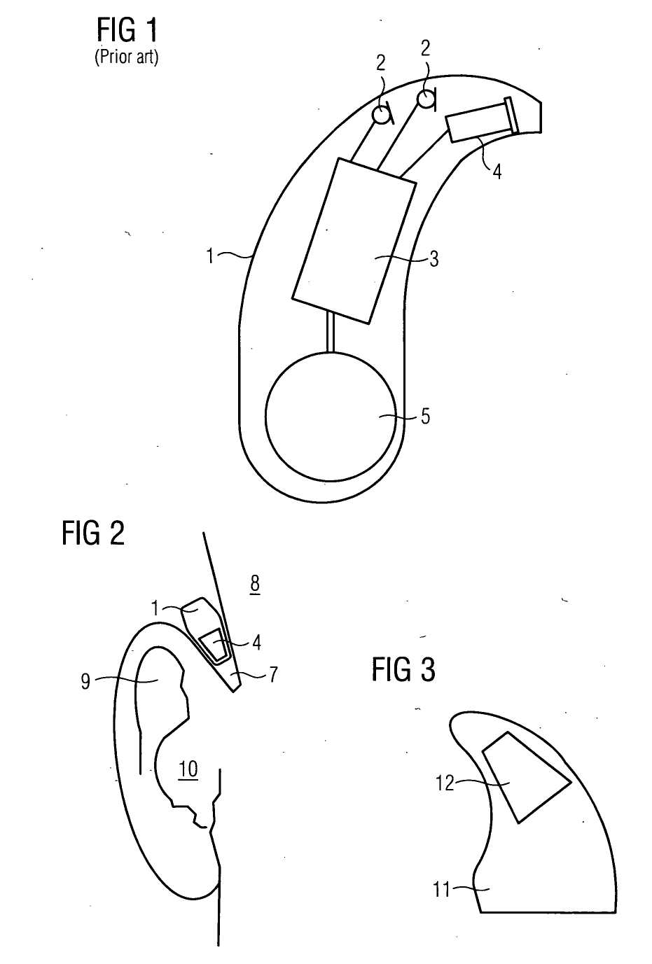

### DETAILED DESCRIPTION OF INVENTION

As FIG. 2 shows, a receiver 4 is located in an upper part of a housing 1 of a behind-the-ear hearing device. The receiver 4 is embodied such that it has a trapezoidal cross-section and is thus adjusted to the lower part of the housing cross-section in respect of the form. The form of the housing 1 itself is adjusted to the anatomical conditions of the hearing device wearer. The housing 1 of the hearing device cannot be designed arbitrarily because the behind-the-ear hearing device is worn in a space 7 between a concha 9 and a head 8 of the hearing device wearer. Particularly with high-performance hearing devices, in which a large receiver 4 is necessary, an extension of the housing 1 as a result of the dimensions of the receiver 4 may be problematical with the use of a conventional square receiver. On the other hand, the receiver 4 with the trapezoidal cross-section allows the entire behind-the-ear hearing device including the housing 1 to be better adjusted to the anatomy of the hearing device wearer. As shown in FIG. 2, the receiver 4 and the housing 1 is embodied such that the behind-the-ear hearing device can be adjusted exactly to the space 7.

Referring to FIG. 3, an in-the-ear hearing device can be used as an alternative to the behind-the-ear hearing device, said in-the-ear hearing device being worn in an auditory canal 10. The in-the-ear hearing device includes a housing 11, as well as a receiver 12 arranged therein. Because the form of the housing 11 in the case of in-the-ear hearing devices is predetermined by the anatomy of the auditory canal 10 and the auditory canal 10 has a different diameter and an individual design, the receiver 12 cannot be configured arbitrarily in the in-the-ear hearing device. The basic idea currently consists in adjusting the form of the receiver 12 to the anatomy of the auditory canal 10. As apparent in FIG. 3, the receiver 12 is embodied such that it has a trapezoidal cross-section. The width of the receiver 12 reduces here and so too do the dimensions of the housing 11 together with the diameter of the auditory canal 10 in the direction of the eardrum. While the dimensions, in particular the width of the receiver are predetermined by the smallest diameter of the auditory canal 10 for a predetermined installation depth in the case of a conventional square receiver, a higher performance of the receiver 12 can be achieved overall as a result of this clever pyramid-like configuration of the receiver 12 and the number of hearing-impaired persons, which can use in-the-ear hearing devices of this type can thus be increased. Alternatively, a receiver 12 with a triangular and/or oval cross-section can also be used here.

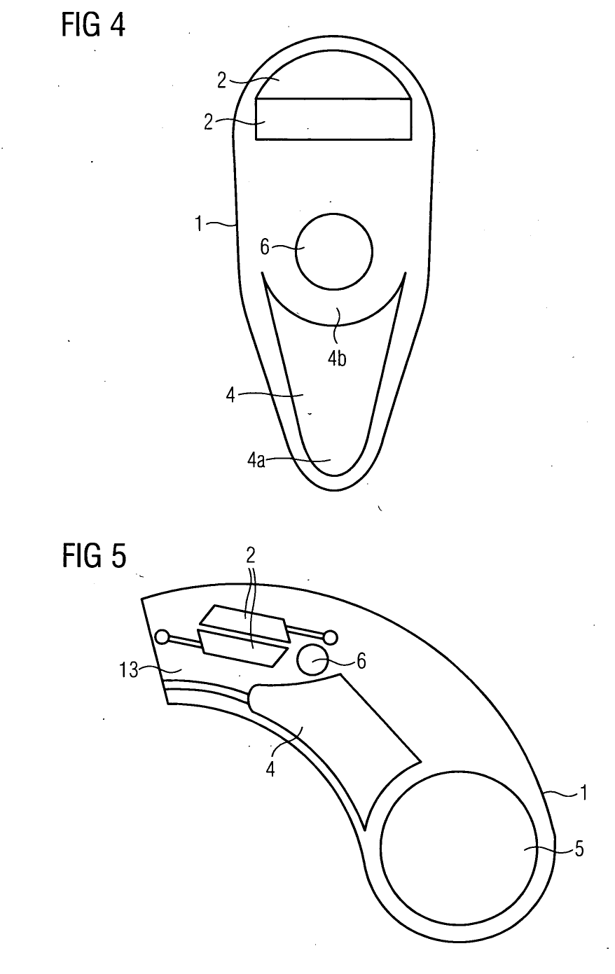

Reference is made below to two different exemplary embodiments of an arrangement of several components in a behind-the-ear hearing device. These exemplary embodiments are shown in FIGS. 4 and 5. According to the first exemplary embodiment, which is shown in FIG. 4, the behind-the-ear hearing device has a receiver 4, an induction coil 6 as well as two microphones 2 arranged adjacent to one other. In this example, the receiver 4 is adjusted adjacent to the housing 1 of the hearing device such that a lower section 4a of the receiver 4 is embodied so as to be rounded. On the other hand, the receiver 4 has an indentation 4b, so that the receiver 4 as a whole adopts the form of an arrowhead. The indentation 4b of the receiver 4 is also embodied such that the receiver 4 partially surrounds the induction coil 6. The receiver 4 is thus adjusted on the one hand to the housing 1 and on the other hand to the induction coil 6. This adjustment in respect of the form of the component allows the free volume available in the hearing device to be used particularly efficiently. By way of example, FIG. 4 shows that the dimensions of the receiver 4 are enlarged compared with a conventional square receiver if it is assumed that the position and the forms of other components remain unchanged.

Furthermore, the microphones 2 located in the housing 1 of the hearing device are not only adjusted to one another but instead also to the housing 1, in respect of form. It is apparent that one of the microphones 2 has a rounded section, which allows an exact adjustment of the microphone 2 to the housing 1. The free volume between the housing 1 and the microphones 2 is thus used optimally.

According to the second exemplary embodiment of an arrangement of several components in the behind-the-ear hearing device in FIG. 5, two microphones 2, a receiver 4, an induction coil 6 as well as a battery 5 are located in a housing 1. The arrangement of the above-cited components is again structured here such that all components are adjusted on the one hand to one another and on the other hand to the housing 1 of the hearing device. The two microphones 2 each have a trapezoidal cross-section here and are also arranged adjacent to one another. This embodiment of the microphones 2 results in turn in a minimization of the free residual volume in the housing 1. The receiver 4 is also embodied such that on the one hand it partially surrounds the battery 5 arranged at one end of the housing 1 and on the other hand protrudes into a free volume 13 formed between the microphones 2 and the housing 1. Furthermore, the induction coil 6 is arranged between the receiver 4 and the microphones 2, so that the free volume is used completely.

1.-6. (canceled)

7. A hearing apparatus, comprising:
a housing which has a predetermined form; and
at least one active, electronic component, which is a receiver or a microphone and which is arranged in the housing, wherein the component has a form, which is adjusted to the form of the housing and to the form of another component of the hearing apparatus.

8. The hearing apparatus as claimed in claim 7, wherein the component housing of the active, electronic component has a trapezoidal, triangular or oval cross-section.

9. The hearing apparatus as claimed in claim 7, wherein the hearing apparatus is an in-the-ear hearing device, with the form of the active, electronic component being adjusted to a shell of the hearing device and the shell being adjusted to the anatomy of an auditory canal of a person wearing the hearing apparatus.

10. The hearing apparatus as claimed in claim 8, wherein the hearing apparatus is an in-the-ear hearing device, with the form of the active, electronic component being adjusted to a shell of the hearing device and the shell being adjusted to the anatomy of an auditory canal of a person wearing the hearing apparatus.

11. The hearing apparatus as claimed in claim 7, wherein the hearing apparatus is a behind-the-ear hearing device, with the form of the active, electronic component being adjusted to a space between a concha and the head of a person wearing the hearing apparatus.

12. The hearing apparatus as claimed in claim 8, wherein the hearing apparatus is a behind-the-ear hearing device, with the form of the active, electronic component being adjusted to a space between a concha and the head of a person wearing the hearing apparatus.

13. The hearing apparatus as claimed in claim 7, wherein the active, electronic component is arranged in direct vicinity to an induction coil and is adjusted to the induction coil such that it surrounds the induction coil at least in sections.

14. The hearing apparatus as claimed in claim 8, wherein the active, electronic component is arranged in direct vicinity to an induction coil and is adjusted to the induction coil such that it surrounds the induction coil at least in sections.

15. The hearing apparatus as claimed in claim 9, wherein the active, electronic component is arranged in direct vicinity to an induction coil and is adjusted to the induction coil such that it surrounds the induction coil at least in sections.

16. The hearing apparatus as claimed in claim 10, wherein the active, electronic component is arranged in direct vicinity to an induction coil and is adjusted to the induction coil such that it surrounds the induction coil at least in sections.

17. The hearing apparatus as claimed in claim 11, wherein the active, electronic component is arranged in direct vicinity to an induction coil and is adjusted to the induction coil such that it surrounds the induction coil at least in sections.

18. The hearing apparatus as claimed in claim 12, wherein the active, electronic component is arranged in direct vicinity to an induction coil and is adjusted to the induction coil such that it surrounds the induction coil at least in sections.

19. The hearing apparatus as claimed in claim 7, wherein the form of the active electronic component is adjusted to the form of the housing of the hearing apparatus such that a rounded section of the component is formed at least in sections.

20. The hearing apparatus as claimed in claim 8, wherein the form of the active electronic component is adjusted to the form of the housing of the hearing apparatus such that a rounded section of the component is formed at least in sections.

21. The hearing apparatus as claimed in claim 9, wherein the form of the active electronic component is adjusted to the form of the housing of the hearing apparatus such that a rounded section of the component is formed at least in sections.

22. The hearing apparatus as claimed in claim 10, wherein the form of the active electronic component is adjusted to the form of the housing of the hearing apparatus such that a rounded section of the component is formed at least in sections.

23. The hearing apparatus as claimed in claim 11, wherein the form of the active electronic component is adjusted to the form of the housing of the hearing apparatus such that a rounded section of the component is formed at least in sections.

24. A hearing apparatus, comprising:
a housing which has a predetermined form; and
at least one active, electronic component, which is a receiver or a microphone and which is arranged in the housing, wherein the component has a form, which is adjusted to the form of the housing or to the form of another component of the hearing apparatus.

25. The hearing apparatus as claimed in claim 24, wherein the component housing of the active, electronic component has a trapezoidal, triangular or oval cross-section.

26. The hearing apparatus as claimed in claim 24, wherein the hearing apparatus is an in-the-ear hearing device, with the form of the active, electronic component being adjusted to a shell of the hearing device and the shell being adjusted to the anatomy of an auditory canal of a person wearing the hearing apparatus.
